(19) United States
(12) Patent Application Publication
(10) Pub. No.: US 2024/0323324 A1
(43) Pub. Date: Sep. 26, 2024

(54) DYNAMIC ANGLE ADJUSTMENT DEVICE FOR A PROJECTOR LIGHT VALVE

(71) Applicant: Young Optics Inc., Hsinchu Science Park (TW)

(72) Inventor: Yu-Chen CHANG, Hsinchu Science Park (TW)

(21) Appl. No.: 18/598,474

(22) Filed: Mar. 7, 2024

(30) Foreign Application Priority Data
Mar. 20, 2023 (TW) 112110312

(51) Int. Cl. H04N 9/31

(52) U.S. Cl. CPC H04N 9/312; H04N 9/3141; H04N 9/3197

(57) ABSTRACT

A dynamic angle adjustment device for a light valve includes a carrier capable of supporting the light valve, a pair of first axes, a pair of second axes, a first actuator and a second actuator. A first part of the first actuator is disposed on the carrier, a second part of the first actuator is disposed on the second outer frame, and the first part and the second part of the first actuator cooperate with each other to generate a force at a distance. A first part of the second actuator is disposed on the first outer frame, a second part of the second actuator is disposed on the second outer frame, and the first part and the second part of the second actuator cooperate with each other to generate a force at a distance.

### CROSS-REFERENCE TO RELATED APPLICATION

This application claims the priority benefit of Taiwan application serial no. 112110312, filed Mar. 20, 2023. The entirety of the above-mentioned patent application is hereby incorporated by reference herein and made a part of this specification.

### BACKGROUND

### Field of the Invention

The invention relates to a dynamic angle adjustment device for a light valve of a projector.

### Description of the Related Art

Currently, a typical projector is often subject to the design constraint that a projection plane needs to make a fixed angle with the optical axis of a projection lens to match the focal plane of the projection lens. Otherwise, the different orientations of the focal plane and the projection plane may cause unbalanced resolution of projection image. However, such design constraint imposed on projectors may limit the application environment and practical usage for projectors.

### BRIEF SUMMARY OF THE INVENTION

In order to achieve one or a portion of or all of the objects or other objects, one embodiment of the invention provides a dynamic angle adjustment device for a light valve of a projector, including a carrier capable of supporting the light valve, a pair of first axes, a pair of second axes, a first actuator and a second actuator. The carrier is connected to a first outer frame via the pair of first axes, and the first outer frame is connected to a second outer frame via the pair of second axes. A first part of the first actuator is disposed on the carrier, a second part of the first actuator is disposed on the second outer frame, and the first part and the second part of the first actuator cooperate with each other to generate a force at a distance. A first part of the second actuator is disposed on the first outer frame, a second part of the second actuator is disposed on the second outer frame, and the first part and the second part of the second actuator cooperate with each other to generate a force at a distance.

Another embodiment of the invention provides a dynamic angle adjustment device for a light valve of a projector, including a carrier capable of supporting the light valve, a first elastic member, a second elastic member, a first actuator and a second actuator. The carrier is connected to an outer frame via the first elastic member and the second elastic member. A first part of the first actuator is disposed in a first position of the carrier, a second part of the first actuator is disposed on the outer frame, and the first part and the second part of the first actuator cooperate with each other to generate a force at a distance. A first part of the second actuator is disposed in a second position of the carrier, a second part of the second actuator is disposed on the outer frame, and the first part and the second part of the second actuator cooperate with each other to generate a force at a distance.

According to the above embodiments, a light valve can tilt or rotate in real-time in at least two dimensions according to the current position or orientation of a target projection plane relative to the optical axis of a projector, and thus orientation angles of the light valve can be adjusted to allow a focal plane of a projection lens to match with the target projection plane as much as possible, thereby achieving a balanced image resolution, i.e. various parts of a projection image all have similar resolutions. Besides, by using driving forces of actuators coupled with resilient forces of flexible/elastic members to tilt the light valve, only two actuators disposed on two adjacent sides of a carrier are needed to rotate or tilt the light valve in real-time in two dimensions, therefore achieving the effect of simplifying the overall drive structure.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1A and FIG. 1B are schematic diagrams for illustrating the effect of a dynamic angle adjustment device for a projector light valve according to an embodiment of the invention.

FIG. 2 is a schematic diagram of a dynamic angle adjustment device for a projector light valve according to an embodiment of the invention.

FIG. 3A and FIG. 3B are schematic cross-sections respectively along line A-A′ and line B-B′ of FIG. 2.

FIG. 4 is a schematic diagram of a dynamic angle adjustment device for a projector light valve according to another embodiment of the invention.

FIG. 5A, FIG. 5B and FIG. 5C are force distribution plots of the carrier shown in FIG. 4.

FIG. 6 is a schematic diagram showing the connection relationship between a dynamic angle adjustment device and surrounding components according to an embodiment of the invention.

FIG. 7 is a schematic diagram of a dynamic angle adjustment device for a projector light valve according to another embodiment of the invention.

### DETAILED DESCRIPTION OF THE INVENTION

In the following detailed description of the preferred embodiments, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. Further, “First,” “Second,” etc, as used herein, are used as labels for nouns that they precede, and do not imply any type of ordering (e.g., spatial, temporal, logical, etc.).

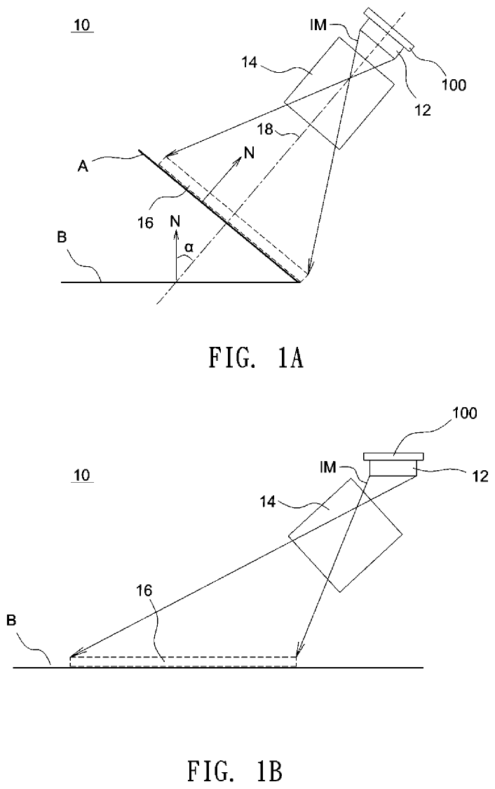

FIGS. 1A and 1B are schematic diagrams for illustrating the effect of a dynamic angle adjustment device for a projector light valve according to an embodiment of the invention. As shown in FIG. 1A, an image beam IM from a light valve 12 of a projector 10 is projected through a projection lens 14 and forms an image on a focal plane 16 of the projection lens 14. Because a normal direction N of a target projection plane A is substantially parallel to the optical axis 18 of the projection lens 14, the focal plane 16 of the projection lens 14 may substantially align and match with the target projection plane A to achieve a balanced image resolution. In contrast, in case the image beam IM is projected on a target projection plane B where a normal direction N of the projection plane B makes an angle a with the optical axis 18 of the projection lens 14, the orientation and position of the focal plane 16 of the projection lens 14 may differ from the orientation and position of the target projection plane B to cause unbalanced resolution of projection images. Therefore, as shown in FIG. 1B, in one embodiment of the invention, the light valve 12 may rotate or tilt in real-time by a dynamic angle adjustment device 100 to adjust the orientation angle of the light valve 12 according to the angle a between the normal direction N of the projection plane B and the optical axis 18. This allows the focal plane 16 to have substantially the same orientation or position as the projection plane B and thus cause each part of a projection image to have a similar resolution. According to the embodiments of the invention, the projection lens 14 is allowed to well perform focusing operations in case the angle a between the normal direction N of a target projection plane and the optical axis 18 is no more than 45 degrees. Therefore, even a user tilts the projector 10 upwards or downwards to a certain degree to perform oblique projection, a competent balanced resolution can be still achieved.

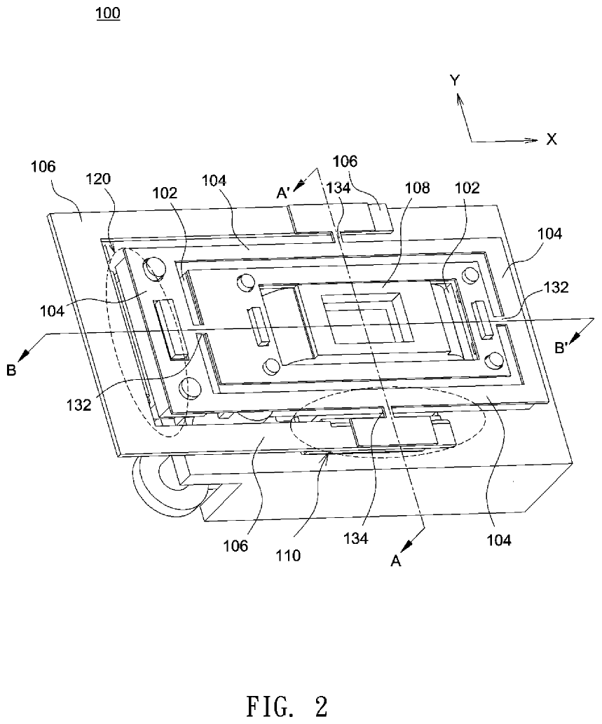

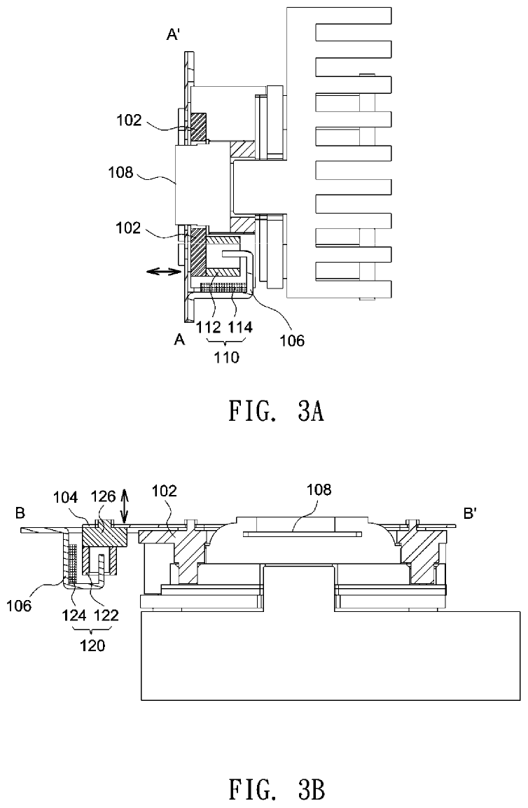

FIG. 2 is a schematic diagram of a dynamic angle adjustment device for a light valve of a projector according to an embodiment of the invention. As shown in FIG. 2, the dynamic angle adjustment device 100 includes a carrier 102, a first outer frame 104, a second outer frame 106, a light valve 108, an actuator 110, and an actuator 120. The light valve 108 is disposed on and supported by the carrier 102, the carrier 102 is connected to the first outer frame 104 by a pair of first axes 132, and the first outer frame 104 is connected to the second outer frame 106 by a pair of second axes 134. In this embodiment, the first axis 132 and the second axis 134 are flexible members. A part of the actuator 110 is disposed on the carrier 102, another part of the actuator 110 is disposed on the second outer frame 106, a part of the actuator 120 is disposed on the first outer frame 104, and another part of the actuator 120 is disposed on the second outer frame 106. FIG. 3A and FIG. 3B are schematic cross-sections respectively along line A-A′ and line B-B′ of FIG. 2, where the arrangements of the actuators 110 and 120 according to an embodiment of the invention are shown. As shown in FIG. 3A, in this embodiment, the actuator 110 includes a coil 112 and a magnet 114, the coil 112 is disposed on the carrier 102, and the magnet 114 is disposed on the second outer frame 106. The coil 112 may cooperate with the magnet 114 to generate a force at a distance. Therefore, the magnet 114 may attract the coil 112 to tilt one end of the carrier 102 in a direction indicated by the arrow shown in FIG. 3A, and thus the light valve 108 disposed on the carrier 102 may reciprocally rotate or tilt about the two first axes 132 as shown in FIG. 2. As shown in FIG. 3B, in this embodiment, the actuator 120 includes a coil 122 and a magnet 124, the coil 122 is housed in a coil seat 126, the coil seat 126 is fixed on the first outer frame 104, and the magnet 124 is disposed on the second outer frame 106. The coil 122 may cooperate with magnet 124 to generate a force at a distance. Therefore, the magnet 124 may attract the coil 122 to tilt one end of the first outer frame 104 in the direction indicated by the arrow shown in FIG. 3B, and thus the light valve 108 disposed on the carrier 102 may reciprocally rotate or tilt about the two second axes 134 as shown in FIG. 2. Further, the arrangement of various parts of an actuator described in the above is only exemplary but not restrictive. For example, the coils 112 and 122 and the magnets 114 and 124 may be exchanged with respect to positions, and the magnet 124 may be housed in a magnet seat (not shown) and then fixed on the first outer frame 104. In other embodiment, the coil 122 or the magnet 124 can be directly fixed on the first outer frame 104 without using a seat such as the coil seat or the magnet seat to achieve the same effect. In addition, the number of actuators may vary according to actual needs without limitation, and the force at a distance may be a magnetic force or an electric force without limitation.

Through the design of the above dynamic angle adjustment device 100, because the light valve 108 can tilt or rotate in real-time in two dimensions (such as the X-axis direction and Y-axis direction shown in FIG. 2) according to the current position or orientation of a target projection plane relative to the optical axis of a projector, the orientation angle of the light valve 108 can be adjusted to allow a focal plane of a projection lens to match with a target projection plane as much as possible, thus achieving a balanced image resolution, i.e. various parts of a projection image all have similar resolutions.

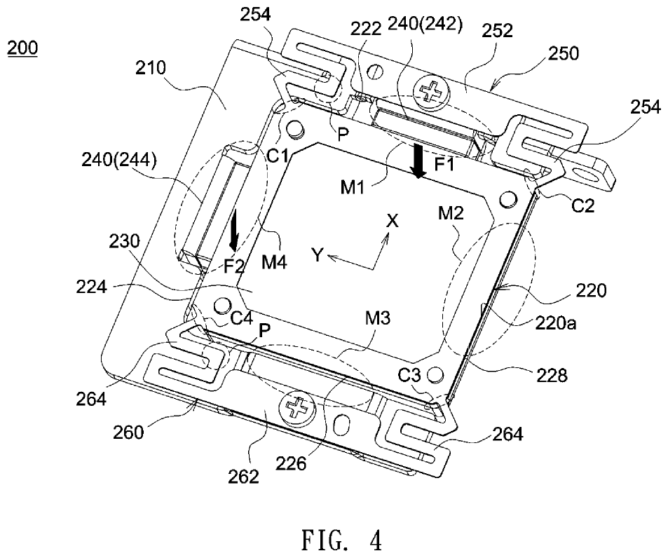

FIG. 4 is a schematic diagram of a dynamic angle adjustment device for a projector light valve according to another embodiment of the invention. As shown in FIG. 4, a dynamic angle adjustment device 200 includes an outer frame 210, a carrier 220 and multiple actuators 240. The carrier 220 is connected to the outer frame 210 by a first elastic member 250 and a second elastic member 260. In one embodiment, the carrier 220 may be a supporting frame or a lens mount that is separate from the light valve 230 or integrally formed as one piece with the light valve 230. In other embodiment, the carrier 220 may be an extension portion directly extending from the elastic member 250 and/or the elastic member 260 to support the light valve 230, but the invention is not limited thereto. In this embodiment, the carrier 220 includes a first side 222, a second side 224, a third side 226 opposite the first side 222, and a fourth side 228 opposite the second side 224, and the light valve 230 is disposed on the carrier 220. The multiple actuators 240 may include an actuator 242 and an actuator 244. A first part of the actuator 242 is disposed on the first side 222 of the carrier 220, and a second part of the actuator 242 is disposed on the outer frame 210. The first part and the second part of the actuator 242 may be two collaborative elements that cooperate with each other to generate a force at a distance. For example, the first part of the actuator 242 is a magnet and the second part of the actuator 242 is a coil, and vice versa. A first part of the actuator 244 is disposed on the second side 224 of the carrier 220, and a second part of the actuator 244 is disposed on the outer frame 210. The first part and the second part of the actuator 244 may be two collaborative elements that cooperate with each other to generate a force at a distance. For example, the first part of the actuator 244 is a magnet and the second part of the actuator 244 is a coil, and vice versa. In this embodiment, the actuator 242 and the actuator 244 are located on the same side of a diagonal line of the carrier 220. Further, in this embodiment, the first elastic member 250 has a fixed part 252 and two movable parts 254 respectively connected with two ends of the fixed part 252, and the second elastic member 260 has a fixed part 262 and two movable parts 264 respectively connected with two ends of the fixed part 262. The movable parts 254 and 264 may rotate or twist, and the fixed parts 252 and 262 are connected with or secured to the outer frame 210 by fasteners such as screws or pins. In this embodiment, the movable part 254 and the movable part 264 are disposed diagonally relative to the carrier 220, and each of the movable parts 254 and 264 may include at least one bending portion P to form two sections that are substantially parallel to two adjacent sides of the carrier 220 respectively. Further, in this embodiment, an outer periphery 220a of the carrier 220 is connected with the first elastic member 250 to form a first connection area C1 and a second connection area C2, and the outer periphery 220a of the carrier 220 is connected with the second elastic member 260 to form a third connection area C3 and a fourth connection area C4. The first connection area C1 and the second connection area C2 define a first middle area M1 located therebetween, the second connection area C2 and the third connection area C3 define a second middle area M2 located therebetween, the third connection area C3 and the fourth connection area C4 define a third middle area M3 located therebetween, and the fourth connection area C4 and the first connection area C1 define a fourth middle area M4 located therebetween. In this embodiment, all middle areas M1-M4 overlap the outer periphery 220a of the carrier 220, and the actuator 242 and the actuator 244 are respectively disposed on the first middle area MI and the fourth middle area M4. In other embodiment, except for the first middle area MI and the fourth middle area M4, either the second middle area M2 or the third middle area M3 may be further provided with an actuator 240. Besides, in this embodiment, the actuator 242 is disposed on an area overlapping the elastic member 250, and a distance between the elastic member 250 and the actuator 242 is smaller than a distance between the elastic member 250 and the actuator 244. When the actuator 242 operates, the actuator 242 may exert a force F1 on the first side 222 of the carrier 220. Moreover, when the actuator 244 operates, the actuator 244 may exert a force F2 on the second side 224 of the carrier 220. For example, the actuator 242 may exert a downward force F1 on the first side 222 to allow the first side 222 of the carrier 220 to move downwardly. Under the circumstance, the elastic member 250 and/or the elastic member 260 simultaneously provides a reverse resilient force to force the carrier 220 to return to its original position. Therefore, the interaction of the force F1 and the resilient force of the elastic member 250 and/or the elastic member 260 allows the first side 222 of the carrier 220 to alternately tilt upwardly and downwardly, so that the light valve 230 on the carrier 220 may tilt in the X-axis direction to reach various orientation angles. Similarly, the actuator 244 may exert a downward force F2 on the second side 224 to allow the second side 224 of the carrier 220 to move downwardly. Under the circumstance, the elastic member 250 and/or the elastic member 260 simultaneously provides a reverse resilient force to force the carrier 220 to return to its original position. Therefore, the interaction of the force F2 and the resilient force of the elastic member 250 and/or the elastic member 260 allows the second side 224 of the carrier 220 to alternately tilt upwardly and downwardly, so that the light valve 230 on the carrier 220 may tilt in the Y-axis direction to reach various orientation angles. In other embodiment, the actuators 242 and 244 may each exert an upward force on the carrier 220 to achieve similar effects of tilting the light valve 230.

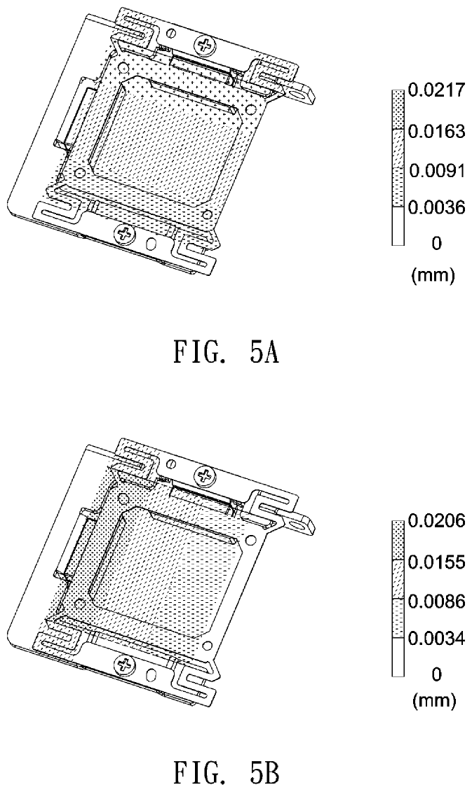

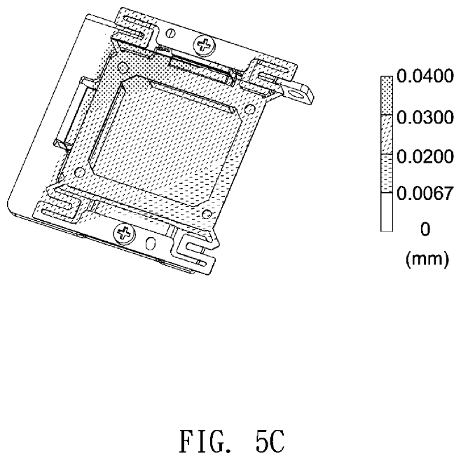

FIGS. 5A, 5B and 5C show force distribution plots of the carrier based on the deflection amount of the carrier, where at least one actuator operates to exert a force on the carrier. FIG. 5A shows the force distribution on the carrier where only the actuator 242 operates, FIG. 5B shows the force distribution on the carrier where only the actuator 244 operates, and FIG. 5C shows the force distribution on the carrier where the actuator 242 and the actuator 244 both operate. Because the carrier 220 may lean toward a position on which a maximum external force is applied, the motion of the carrier caused by the actuator 242 and/or the actuator 244 can be recognized by referencing FIGS. 5A-5C indicative of the degree of force (the deflection amount) on different portions of the carrier 220. For example, by alternating different control modes including (1) only the actuator 242 actuates, (2) the actuator 242 and the actuator 244 both actuate, and (3) only the actuator 244 actuates, the light valve 230 on the carrier 220 is allowed to tilt or rotate in real-time in two dimensions (such as the X-axis direction and Y-axis direction shown in FIG. 4) according to the current position or orientation of a target projection plane relative to the optical axis, and thus the light valve 230 can be adjusted to allow a focal plane of a projection lens to match with the target projection plane as much as possible to achieve a balanced image resolution, i.e. various parts of a projection image all have similar resolutions.

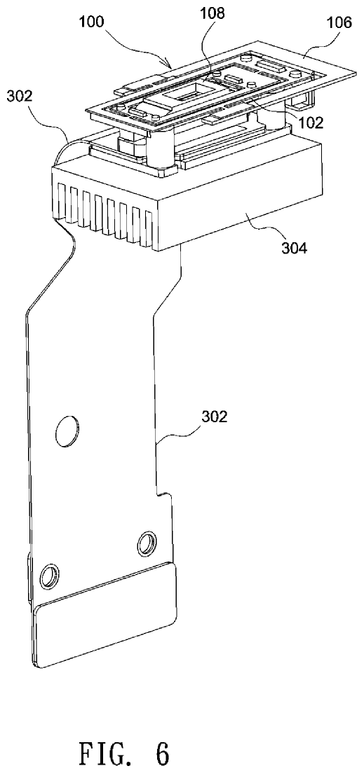

FIG. 6 is a schematic diagram showing the connection relationship between a dynamic angle adjustment device and surrounding components according to an embodiment of the invention. As shown in FIG. 6, the dynamic angle adjustment device 100 may connect a flexible circuit board 302 to transmit control signals to control orientation angles of the light valve 108 in real-time, and a radiator 304 may be provided under the dynamic angle adjustment device 100. In one embodiment, when the carrier 102 and the light valve 108 disposed thereon rotate, the flexible circuit board 302 and the radiator 304 may move together. Moreover, the outer frame 106 may be secured to the interior of a projector housing (not shown).

The term “light valve”, which is commonly known in the projector industry, refers to individually-addressed optical units of a spatial light modulator. The spatial light modulator includes multiple individually-addressed optical units arranged as a one-dimensional or a two-dimensional array. Each optical unit can be individually addressed by optical or electrical signals to alter its optical properties through various physical effects (e.g., Pockels effect, Kerr effect, photo-acoustic effect, pagneto-optic effect, self electro-optic effect or photorefractive effect). Therefore, the multiple individually addressed optical units may modify incoming light beams and output image beams. The optical units may be, for example, micro mirrors or liquid crystal cells, and the light valve may be a digital micro-mirror device (DMD), a liquid-crystal-on-silicon panel (LCOS panel), an LCD panel, or a micro LED panel.

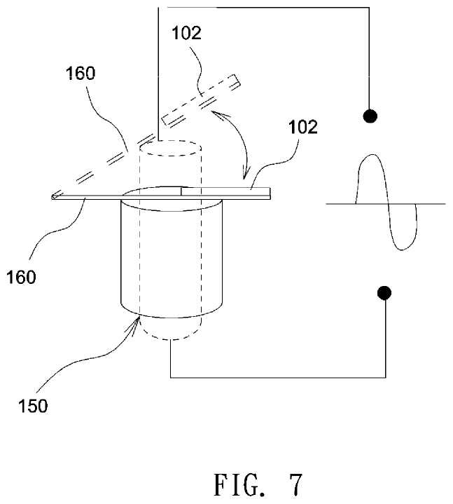

In at least some embodiments of the invention, a light valve is disposed on a carrier, and a mover and a stator are respectively provided at corresponding positions selected from the carrier, the first outer frame, and the second outer frame. The stator may be a magnet and the mover may be a magnetosensitive element, and vice versa. The carrier may rotate or tilt by the interaction of the stator and the mover. The magnetosensitive element may be a conductive wire or a magnetic conductive material, and the magnet may be a permanent magnet or an electromagnet. The arrangement and magnetic force action area of the magnetosensitive component and the magnet may vary according to actual needs without limitation. However, the invention is not limited to using the magnetic force as a driving force to actuate the light valve. In other embodiment as shown in FIG. 7, the stator is a piezoelectric element 150, the mover is a linkage element 160, and the carrier 102 is disposed on the linkage element 160. The piezoelectric element 150 may extend or shrink to result in deformation when an electric field is applied, converting electrical energy into mechanical energy, to cause reciprocate movement of the carrier 102 and thus change orientation angles of the light valve.

Further, the light valve may tilt in two axial directions or more without limitation. In addition, the type of an axis is not limited. As shown in FIG. 2, a pair of flexible members may form a real physical axis, and the light valve may tilt about the real physical axis. Alternatively, as shown in FIG. 4, the light valve may tilt about a virtual axis (such as the X-axis direction or Y-axis direction), and the virtual axis does not coincide with the elastic members 250 and 260.

According to the above embodiments, a light valve can tilt or rotate in real-time in at least two dimensions according to the current position or orientation of a target projection plane relative to the optical axis of a projector, and thus the orientation angle of the light valve can be adjusted to allow a focal plane of a projection lens to match with the target projection plane as much as possible, thereby achieving a balanced image resolution, i.e. various parts of a projection image all have similar resolutions. Besides, by using driving forces of actuators coupled with resilient forces of flexible/elastic members to tilt the light valve, only two actuators disposed on two adjacent sides of a carrier are needed to rotate or tilt the light valve in real-time in two dimensions, therefore achieving the effect of simplifying the overall drive structure.

Though the embodiments of the invention have been presented for purposes of illustration and description, they are not intended to be exhaustive or to limit the invention. Accordingly, many modifications and variations without departing from the spirit of the invention or essential characteristics thereof will be apparent to practitioners skilled in this art. It is intended that the scope of the invention be defined by the claims appended hereto and their equivalents in which all terms are meant in their broadest reasonable sense unless otherwise indicated.

What is claimed is:

1. A dynamic angle adjustment device for a light valve of a projector, comprising:
a carrier capable of supporting the light valve;
a pair of first axes, wherein the carrier is connected to a first outer frame via the pair of first axes;
a pair of second axes, wherein the first outer frame is connected to a second outer frame via the pair of second axes;
a first actuator, wherein a first part of the first actuator is disposed on the carrier, a second part of the first actuator is disposed on the second outer frame, and the first part and the second part of the first actuator are capable of cooperating with each other to generate a force at a distance; and
a second actuator, wherein a first part of the second actuator is disposed on the first outer frame, a second part of the second actuator is disposed on the second outer frame, and the first part and the second part of the second actuator are capable of cooperating with each other to generate a force at a distance.

2. The dynamic angle adjustment device as claimed in claim 1, wherein each of the first axes and the second axes is a flexible member.

3. The dynamic angle adjustment device as claimed in claim 1, wherein the first part of the second actuator is housed in a seat, and the seat is fixed on the first outer frame.

4. The dynamic angle adjustment device as claimed in claim 1, wherein the first actuator and the second actuator are located on the same side of a diagonal line of the carrier.

5. The dynamic angle adjustment device as claimed in claim 1, wherein the first part of the first actuator is a coil and the second part of the first actuator is a magnet, or the first part of the first actuator is a magnet and the second part of the first actuator is a coil.

6. The dynamic angle adjustment device as claimed in claim 1, wherein the first part of the second actuator is a magnet and the second part of the second actuator is a coil, or the first part of the second actuator is a coil and the second part of the second actuator is a magnet.

7. The dynamic angle adjustment device as claimed in claim 1, wherein the light valve is a digital micro-mirror device, a liquid-crystal-on-silicon panel, an LCD panel, or a micro LED panel.

8. The dynamic angle adjustment device as claimed in claim 1, wherein the force at a distance is a magnetic force or an electric force.

9. The dynamic angle adjustment device as claimed in claim 1, wherein the first part of the first actuator is a coil, the second part of the first actuator is a magnet, and the magnet is capable of attracting the coil to tilt one end of the carrier.

10. The dynamic angle adjustment device as claimed in claim 1, wherein the first part of the second actuator is a coil and the second part of the second actuator is a magnet, the coil is housed in a coil seat, and the magnet is capable of attracting the coil to tilt one end of the first outer frame.

11. A dynamic angle adjustment device for a light valve of a projector, comprising:
a carrier capable of supporting the light valve;
a first elastic member and a second elastic member, wherein the carrier is connected to an outer frame via the first elastic member and the second elastic member;
a first actuator, wherein a first part of the first actuator is disposed in a first position of the carrier, a second part of the first actuator is disposed on the outer frame, and the first part and the second part of the first actuator are capable of cooperating with each other to generate a force at a distance; and
a second actuator, wherein a first part of the second actuator is disposed in a second position of the carrier different to the first position, a second part of the second actuator is disposed on the outer frame, and the first part and the second part of the second actuator are capable of cooperating with each other to generate a force at a distance.

12. The dynamic angle adjustment device as claimed in claim 11, wherein each of the first elastic member and the second elastic member includes a first section and a second section, and the first section and the second section extend in different directions.

13. The dynamic angle adjustment device as claimed in claim 11, wherein the first actuator and the second actuator are located on a same side of a diagonal line of the carrier.

14. The dynamic angle adjustment device as claimed in claim 11, wherein the first part of the first actuator is a coil and the second part of the first actuator is a magnet, or the first part of the first actuator is a magnet and the second part of the first actuator is a coil.

15. The dynamic angle adjustment device as claimed in claim 11, wherein the first part of the second actuator is a magnet and the second part of the second actuator is a coil, or the first part of the second actuator is a coil and the second part of the second actuator is a magnet.

16. The dynamic angle adjustment device as claimed in claim 11, wherein the light valve is a digital micro-mirror device, a liquid-crystal-on-silicon panel, an LCD panel, or a micro LED panel.

17. The dynamic angle adjustment device as claimed in claim 11, wherein the force at a distance is a magnetic force or an electric force.

18. The dynamic angle adjustment device as claimed in claim 11, wherein at least one of the first actuator and the second actuator is disposed on an area overlapping the first elastic member.

19. The dynamic angle adjustment device as claimed in claim 11, wherein a distance between the first elastic member and the first actuator is smaller than a distance between the first elastic member and the second actuator.

20. The dynamic angle adjustment device as claimed in claim 11, wherein an outer periphery of the carrier is connected with the first elastic member to form a first connection area and a second connection area, the outer periphery of the carrier is connected with the second elastic member to form a third connection area and a fourth connection area, the first connection area and the second connection area defines a first middle area between the first connection area and the second connection area, the second connection area and a third connection area defines a second middle area between the second connection area and a third connection area, the third connection area and the fourth connection area defines a third middle area between the third connection area and the fourth connection area, and the fourth connection area and the first connection area defines a fourth middle area between the fourth connection area and the first connection area, and at least two and at most three middle areas of the first, the second, the third and the fourth middle areas are each provided with an actuator.
